(19) United States
(12) Patent Application Publication
(10) Pub. No.: US 2012/0022914 A1
(43) Pub. Date: Jan. 26, 2012

(54) Web based System for collecting, storing, and distributing customer review/comment information, to aid with more informed decisions at the point of sale or service

(76) Inventors: Edward M. Thomas, Tinton Falls, NJ (US); Laurie T. Thomas, Tinton Falls, NJ (US)

(21) Appl. No.: 12/843,873

(22) Filed: Jul. 26, 2010

(51) Int. Cl. G06F 17/30; G06F 17/00; G06Q 30/00

(52) U.S. Cl. 705/7.29; 705/26.7; 705/14.66; 235/375

(57) ABSTRACT

Disclosed is a web based system for collecting user and merchant information and making that information available to users and merchants at the point of sale or service to aid in product or service selection. In a specific embodiment, a customer, upon being waited on at a restaurant is presented with a handheld computer device which enables the user to login to the backend server and review comments to previous experiences of a menu item to aid in menu selection. These comments may be personal comments or comments made by other users of the same product or service. Upon logging into the system, an email is sent to the user reminding them that they visited the merchant and can provide comments at the user's convenience. The user is also able to use this capability to determine what merchant may have a product of interest based upon predefined preferences.

### BACKGROUND OF THE INVENTION

1. Field of the Invention

This invention relates to a web based system which enables a customer to use previous comments/reviews of selected items at a point of sale/service to make future informed decisions. More particularly, as customers visit restaurants they routinely try to recall what they ordered on previous occasions at that restaurant. Invariably, they do not recall and unfortunately will choose the undesired selection again. Additionally, it would be very helpful to know how other customers feel about given menu selections prior to making a personal transaction. As such, the object of this invention is to collect user information including user comments/reviews regarding menu selection, meal ordering dates, restaurants visited and quality of the meals to aid the customer in future menu selection. Further, this invention also applies to other areas other than restaurants where user comments/reviews can aid in making future informed decisions.

2. Description of Prior Art

The use of the internet for users/customers to access their accounts, share reviews/comments is fairly widely used today. Which includes blogs, chat rooms, and social websites and message boards; however, the use of personal purchase or transaction history, personal review histories and user selection indicators for future decision making has not been integrated for use at the point of sale or service. The present invention is a web based system which enables the user/customer and the merchant to share information and benefit from user experience information.

### BRIEF SUMMARY OF THE INVENTION

The object of the present invention is to provide a means where users/customers may have the necessary resources to make informed decisions based on prior experience at the point of sale or service. For example, a customer upon returning to a restaurant (or any of the other restaurants in a restaurant chain) desires to recall a previous meal selection. This invention provides the customer a record of their previous reviews/comments at any participating restaurant/merchant. It also enables the customer to review comments by other customers if desired prior to making a transaction. This recording system also applies to other industry areas where user comments can help in making informed decisions. The user/customer may now view a web based report on a handheld device or receive a printout showing the historical review information.

### BRIEF DESCRIPTION OF THE SEVERAL VIEWS OF THE DRAWING

The embodied figures depict a web based system whereby users' comments/reviews are recorded and used for future transaction decisions.

FIG. 1, provides a dataflow of how users are able to access the data from the backend servers while

FIG. 2, provides graphic of the physical connectivity and the means for user authentication.

### DETAILED DESCRIPTION OF THE INVENTION

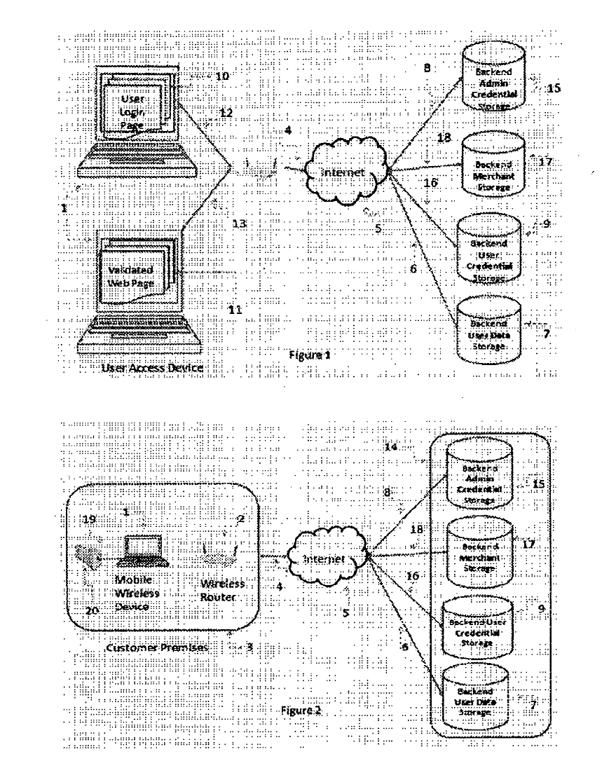

Referring to FIG. 1, the customer is provided with a mobile, handheld or desktop web enabled user-access-device 1 of this invention. The user/customer then enters his assigned username, password and merchant number (credentials) into a login screen on the device's browser 10 of the web server 14 at the web server's URL. Upon entering the user's credentials, the user's credentials are checked against the credentials stored in the credential storage 9, via connectivity over network paths 12, 2, 4, 5 and 16. Administrative credentials are checked over network connections 12, 2, 4, 5, and 8. Merchant credentials are checked over the network connection 12, 2, 4, 5, 18, 17. If the credentials are validated, the user will be granted approval to view the validated web page 11 with content from storages 9, 15, 17 respectively.

Alternatively, a customer may use a swipe 19 card provided as a part of the web based system to gain access to the web server 14, by swiping it thru a card reader 20. The swipe card reader 20 is connected to the user-access-device 1, via the devices' 158 or serial ports. The user is able to swipe the card and enter a pass-code as the needed credentials.

Upon loggin into the website, the user will automatically be sent an email to the email address of record confirming the said transaction. This said email address will be the email address of record stored in the user data store 9. Upon receipt of an email of the transaction record, the email message will ask the user/customer to enter a comment/review on the selection of menu or product choice at the said merchant. The user/customer may also be sent an additional from the system after merchant confirms the choice of product or service delivered.

Referring to FIG. 1, the user is able to view records of previous personal comments/reviews or reviews made by other customers, stored on user data store 7.

Referring to FIG. 2, connectivity between the user-access-device 1 and the wireless router 2 can be a wired or wireless connection within a plurality of customer premises 3.

Web browsers such as NETSCAPE, a trademark of Netscape, inc., MICROSOFT INTERNET EXPLORER, a trademark of Microsoft, Inc. or GOGGLE CHROME, a trademark of Google, Inc. provide access over the World-Wide-Web via web pages 10 and 11.

Also in FIG. 2, backend user-data-storage 7, backend user-credential-storage 9, backend-merchant-storage 17 and backend-admin-storage 15 are accessed via web servers 14.

The user-access-device 1 may be Personal Computer (PC), Laptop, notebook, ipad, Mack book, cell-phone or any device which has web browser capability, where Ipad and Mack book are trademarks of APPLE.Inc.

The user is able to define their menu preferences. This enables the customer to target merchants in a given locale who can potentially provide a desired menu/product/service choice.

Upon access to the Website 11, the customer is able to review the choice of the merchant's products or menu items presented from web server 14. The user is then presented with the options of making new comments to any of the menu choices or simply review the comments made previously. The user is also able to select a checkbox to establish the privacy level of the information they have entered. The user's data is then correlated with other user data for statistical purposes. This data is made available to merchants or other statisticians for statistical purposes. The customer may opt in or out of the email confirmations of transactions notifications.

Potential customers may be signed up as users of the system by the merchant, administrators or by the users themselves at the point of sale or service or from anywhere on the internet.

Merchants are able to login with their merchant credentials and created menu listing of their products or services. This will be the list of products or menu items against which the customers will make their comments/reviews.

Advertisement's are incorporated into designated web pages 11 based upon regional areas of interest, or based on targeted demographic.

Administrative tasks such as adding/updating user, merchant and admin information are accomplished via the web page 11 using administrative credentials stored on the user storage 9, administrative credential storage 15 or merchant storage 17.

For enhanced customization and security, the merchant provided user-access-device may be keyed to the particular merchant's account. Key codes are stored on each merchant provided user-access-device. If the merchant code entered by the user does not match the code on the device, an email is sent to the merchant(s) indicating that the device is not associated with his establishment. This ensures provides a certain level of uniqueness and security for user devices. This customization is accomplished by comparing the key on the user-access-device to the key located in the user credential storage 17 as a part of the authentication process.

While the invention has been described with reference to the preferred embodiment thereof, it is apparent that changes may be made to the components and their arrangement without departing from the scope of the invention hereafter claimed.

What is claimed is:

1. A web based system, which enables a customer to use previous reviews/comments to make future informed decisions comprising;
A web enabled user-access-device connected to a backend web server via the Internet;
Wherein a web page on the said user-access-device, enables a user to enter personal user credentials for access to the validated-user WebPages;
Wherein said webPages on the said user-access-device, enables a user to evaluate of personal comments/reviews and comments/reviews of other customers relative to a given product or menu selection;
Wherein said web based system enables said users, customers, administrators and merchants to enter, retrieve and update personal data.
Wherein said WebPages enable said customers to have access to said reviews locally, nationally or internationally;
Wherein output of said WebPages can be printed and made available to said customers by a merchant or by the said customer, including at the point of sale or service;
Wherein users, may retrieve said customer/user data via mobile, hand held or desktop devices at the point of sale.

2. A web based system which enables prospective customers to define their preferences comprising;
a. Products or services that meet the specified criteria of a targeted region;
b. Privacy levels of the information they enter;
c. Selectable option to opt-out of emails in connection with customer transaction activities.

3. A web based system which incorporates advertisements comprising;
a. A customer's validated web page which hosts advertisements of other local merchants in the area, with other types of products or services; thus enabling the customer to know about other featured products while viewing data of the current merchant;
b. A customers validated web page as in 3.a, which hosts advertisements of other local merchants in the area, with similar products or services.
c. Targeted advertising based on demographics such as age range, gender, etc.

4. Web based system which enables a merchant to perform tasks comprising;
a. Creating a menu listing, including descriptions of their products or services for said customers to make their comments/reviews against said listing;
b. Create, store and publish advertisements so that potential customers may be attracted to the merchant's establishment;
c. Review of customer ordering pattern statistics, including correlated statistics across all customers;
d. Timely insight into satisfied/dissatisfied customer reactions to product quality.

5. A web based system which performs administrative functions comprising;
a. Administratively adding and updating customer, merchant and administrator information;
b. A web based system where said customers, merchants, administrators can be added or removed from the said system;
c. A web based system for said merchants to add/update their product and contact information;
d. An email to be sent to the customer confirming activity at that said merchant which gives the customer the opportunity to login to their account and enter comments/reviews regarding the said transaction;
e. The said user may also be sent an additional email, from the said system after said merchant confirms the choice of product or service delivered;
f. Backend databases where customers', merchants' and administrators' data and credentials are stored;
g. A web based system which enabling potential customers to sign up for product/services at the point of sale or service or from anywhere an the internet;
h. Key codes on each merchant provided user-access-device for correlation with the information stored in the backend-merchant-storage, wherein if the key code does not match the said code on the said backend-merchant-storage device, an email is sent to the merchant(s) that the said device is not associated with his establishment.
i. A swipe card reader connected to the said user-access-device which accepts a magnetic swipe card for authenticating said user access.
